(19) United States
(12) Patent Application Publication
(10) Pub. No.: US 2023/0319845 A1
(43) Pub. Date: Oct. 5, 2023

(54) METHOD, APPARATUS AND SYSTEM FOR A CONTROL CHANNEL MONITORING PROCEDURE

(71) Applicant: ZTE CORPORATION, Shenzhen, (CN)

(72) Inventors: Qiujin GUO, Shenzhen (CN); Mengzhu CHEN, Shenzhen (CN); Xiaoying MA, Shenzhen (CN); Jun XU, Shenzhen (CN); Qiang FU, Shenzhen (CN); Jian KANG, Shenzhen (CN)

(73) Assignee: ZTE CORPORATION, Shenzhen (CN)

(21) Appl. No.: 18/112,546

(22) Filed: Feb. 22, 2023

Related U.S. Application Data
(63) Continuation of application No. PCT/CN2020/121618, filed on Oct. 16, 2020.

(51) Int. Cl. H04W 72/232; H04W 72/1273

(52) U.S. Cl. CPC H04W 72/232; H04W 72/1273

(57) ABSTRACT

A wireless communication method for use in a wireless terminal is disclosed. The method comprises monitoring a physical downlink control channel, PDCCH, according to a first group of search space sets in a plurality of groups of search space sets based on a type of the first group of search space sets, wherein the first group of search space sets in the plurality of groups of search space sets is determined based on control information.

This application is a continuation of PCT/CN2020/121618, filed Oct. 16, 2020, the content of which is incorporated herein by reference in its entirety.

### TECHNICAL FIELD

This document is directed generally to wireless communications.

### BACKGROUND

In the existing communication systems including long term evolution (LTE) and 5G new radio (NR) access technology communication systems, there are many distinctive classes of use cases, for example, enhanced mobile broadband (eMBB), massive machine type communication (mMTC) and ultra-reliable and low-latency communication (URLLC), etc. These use cases correspond to their own requirements, e.g. higher data rate, higher reliability, lower latency and/or very low device energy (to support a longer battery life time), etc. Though these requirements are artificial, they are available for current or future mobile communication, e.g. wearable devices, cloud gaming, and AR/VR (augmented reality/virtual reality) applications, etc. For the requirement of very low device energy, some techniques have been specified to save UE power consumption, for example, discontinuous reception (DRX), downlink control information (DCI) carrying wake-up indication (WUS), secondary cell (SCell) dormancy behavior and cross-slot scheduling, i.e. minimum applicable scheduling offset indication for the minimum applicable K0, the minimum applicable K2 and the minimum applicable value of aperiodic CSI-RS triggering offset. However, from the below analysis, it is observed that power consumption in physical downlink control channel (PDCCH)-only state still domains the most, where the PDCCH-only state represents the behavior that a UE monitors a PDCCH not carrying a DCI.

### SUMMARY

On one hand, the UE needs to keep monitoring PDCCH in PDCCH monitoring occasions to avoid missing any UL/DL transmission information. The PDCCH monitoring occasion(s) is determined by parameters of periodicity kₛ, a duration Tₛ in a periodicity and an offset Oₛ associated with the start position of a periodicity, e.g. the PDCCH monitoring occasions with Tₛ=1 slot and kₛ =2 slots in FIG. 1A. The discontinuous reception (DRX) mechanism and wake-up indication are induced which may ensure a UE to avoid some PDCCH monitoring power consumption during the DRX Active Time shown in FIG. 1B.

In FIGS. 1A and 1B, it can be seen that although PDCCH monitoring occasion(s) in FIG. 1A consumes much more power than that in FIG. 1B, most of the power consumption on PDCCH monitoring in FIG. 1B is unnecessary for the UE during DRX Active Time when the data arrival is sparser and the DRX inactivity timer is longer.

The present disclosure relates to methods of combining search space set group switching with at least one of minimum applicable scheduling offset, secondary cell (SCell) dormancy behavior and PDCCH skipping to save UE power consumption and meet the requirements of low device energy.

The present disclosure relates to a wireless communication method for use in a wireless terminal. The method comprises monitoring a physical downlink control channel, PDCCH, according to a first group of search space sets in a plurality of groups of search space sets based on a type of the first group of search space sets, wherein the first group of search space sets in the plurality of groups of search space sets is determined based on control information.

Various embodiments may preferably implement the following features:

Preferably, or in some implementations, the type of the first group of search space sets comprises at least one of a switching search space set group, an uplink search space set group, a downlink search space set group, or a skipping search space set group.

Preferably, or in some implementations, the wireless terminal monitors PDCCH according to search space sets of the first group of search space sets for detecting one or more DCI formats when the type of the first group of search space sets is an uplink search space set group, and wherein one or more DCI formats carry information corresponding to an uplink scheduling.

Preferably, or in some implementations, the wireless terminal monitors PDCCH according to search space sets of the first group of search space sets for detecting one or more DCI formats when the type of the first group of search space sets is a downlink search space set group, and wherein one or more DCI formats carry information corresponding to a downlink scheduling.

Preferably, or in some implementations, the type of the first group of search space sets changes between at least two of the switching search space set group, the uplink search space set group, the downlink search space set group and a skipping search space set group when at least two types of the switching search space set group, the uplink search space set group, the downlink search space set group, or the skipping search space set group are configured for at least one of the search space sets in the first group of search space sets.

Preferably, or in some implementations, the type of the first group of search space sets is a skipping search space set group and the first group of search space sets includes at least one search space set associated with one or more DCI formats.

Preferably, or in some implementations, the monitoring the PDCCH according to the first group of search space sets in the plurality of groups of search space sets based on the type of the first group of search space sets comprises stopping monitoring the PDCCH for detection of one or more DCI formats according to the first group of search space sets during a skipping period. Wherein the skipping period is not smaller than 0 and the unit of the skipping period is slot or millisecond.

Preferably, or in some implementations, the one or more DCI formats include at least one of DCI format 0-1, DCI format 1-1, DCI format 0-2 or DCI format 1-2.

Preferably, or in some implementations, a search space set configured for the wireless terminal is configured in at least one of a group of search space sets having the type of an uplink search space set group and a group of search space sets having the type of a downlink search space set group.

Preferably, or in some implementations, the type of the first group of search space sets comprises the type of an uplink search space set group and/or a downlink search space set group, the type of the first group of search space sets is determined based on at least one of the control information or at least one condition, the control information includes at least one of search space set group information indicated by a DCI, the DCI format, the type of the uplink search space set group, the type of the downlink search space set group, and the release version configured by a higher layer signaling, and the at least one condition is associated with at least one of a budget size difference between DCI format 0-1 and DCI format 1-1, or a budget size difference between DCI format 0-2 and DCI format 1-2.

Preferably, or in some implementations, an indication indicating the type of the first group of search space sets being an uplink search space set group and/or a downlink search space set group is invalid or not presented when the control information is not configured for the wireless terminal, and the control information includes at least one of the DCI format, the bitwidth of search space set group information indicated by the DCI, the type of the uplink search space set group, the type of the downlink search space set group, and a release version configured by a higher layer signaling.

Preferably, or in some implementations, the type of the first group of search space sets is determined based on information indicated by a DCI and/or a release version when at least one of the type of a switching search space set group, the type of an uplink search space set group, the type of a downlink search space set group and the type of a skipping search space set group is configured for the wireless terminal.

Preferably, or in some implementations, an identification of the first group of search space sets is determined based on at least one of search space set group information indicated by a DCI, the type of a switching search space set group, the type of an uplink search space set group, the type of a downlink search space set group, the type of a skipping search space set group, and a release version configured by a higher layer signaling.

Preferably, or in some implementations, the control information is associated with an indication of the minimum applicable scheduling offset.

Preferably, or in some implementations, the indication of the minimum applicable scheduling offset comprises at least one of: a DCI format, the minimum applicable value of a scheduling offset between the DCI and a physical downlink shared channel, PDSCH, scheduled by the DCI, the minimum applicable value of a scheduling offset between a slot containing the DCI triggering a set of the reference signal resources and another slot in which the set of reference signal resources is transmitted, the minimum applicable value of a scheduling offset between the DCI and a physical uplink shared channel, PUSCH, scheduled by the DCI, a value of a field indicating the minimum applicable scheduling offset, a bit width of the field indicating the minimum applicable scheduling offset, the number of values configured by a first higher layer parameter corresponding to the minimum applicable value of the scheduling offset between the DCI and the PDSCH scheduled by the DCI, or the number of values configured by a second higher layer parameter corresponding to the minimum applicable value of the scheduling offset between the DCI and the PUSCH scheduled by the DCI.

Preferably, or in some implementations, the first group of search space sets is configured as per downlink bandwidth part.

Preferably, or in some implementations, the control information is associated with at least one of a carrier indicator or a secondary cell dormancy indication in a DCI.

Preferably, or in some implementations, the monitoring the PDCCH according to the first group of search space sets in the plurality of groups of search space sets based on the type of the first group of search space sets comprises not monitoring the PDCCH according to the first group of search space sets in the cell indicated by the carrier indicator and the cells in a cell group bundled for monitoring PDCCH if the cell group bundled for monitoring PDCCH according to the first group of search space sets is configured for the wireless terminal.

Preferably, or in some implementations, the secondary cell dormancy indication is valid for one or more groups of serving cells, and the monitoring the PDCCH according to the first group of search space sets in the plurality of groups of search space sets based on the type of the first group of search space sets comprises: monitoring the PDCCH according to the first group of search space sets in at least one cell other than the one or more groups of serving cells supporting secondary cell dormancy behavior.

Preferably, or in some implementations, the control information is indicated by a DCI and comprises a bitmap indicating one or more cell groups where the wireless terminal monitors the PDCCH according to the first group of search space sets in the plurality of groups of search space sets.

Preferably, or in some implementations, one or more bits of the bitmap indicates a group identification of one of the plurality of groups of search space sets for the corresponding cell or cell group.

The present disclosure relates to a wireless communication method for use in a wireless network node. The method comprises transmitting, to a wireless terminal, downlink control information, DCI, on a physical downlink control channel, PDCCH, according to a first group of search space sets in a plurality of groups of search space sets based on a type of the first group of search space sets, wherein the first group of search space sets in the plurality of groups of search space sets is determined based on control information.

Various embodiments may preferably implement the following features:

Preferably, or in some implementations, the type of the first group of search space sets comprises at least one of a switching search space set group, an uplink search space set group, a downlink search space set group, or a skipping search space set group.

Preferably, or in some implementations, the type of the first group of search space sets is an uplink search space set group, and the DCI is associated with one or more DCI formats carrying information corresponding to an uplink scheduling.

Preferably, or in some implementations, the type of the first group of search space sets is a downlink search space set group, and the DCI is associated with one or more DCI formats carrying information corresponding to a downlink scheduling.

Preferably, or in some implementations, the type of the first group of search space sets changes between at least two of the switching search space set group, the uplink search space set group, the downlink search space set group and a skipping search space set group when at least two types of the switching search space set group, the uplink search space set group, the downlink search space set group, or the skipping search space set group are configured for at least one of the search space sets in the first group of search space sets.

Preferably, or in some implementations, the type of the first group of search space sets is a skipping search space set group and the first group of search space sets includes at least one search space set associated with one or more DCI formats.

Preferably, or in some implementations, the transmitting, to the wireless terminal, the DCI on the PDCCH according to the first group of search space sets in the plurality of search space sets based on the type of the first group of search space sets comprises stop transmitting, to the wireless terminal, the DCI associated with one or more DCI formats according to the first group of search space sets during a skipping period. Wherein the skipping period is not smaller than 0 and the unit of the skipping period is slot or millisecond.

Preferably, or in some implementations, the one or more DCI formats includes at least one of DCI format 0-1, DCI format 1-1, DCI format 0-2 or DCI format 1-2.

Preferably, or in some implementations, the wireless network node configures a search space set for the wireless terminal in at least one of a group of search space sets having the type of an uplink search space set group and a group of search space sets having the type of a downlink search space set group.

Preferably, or in some implementations, the type of the first group of search space sets comprises the type of an uplink search space set group and/or a downlink search space set group, the type of the first group of search space sets is determined based on at least one of the control information or at least one condition, the control information includes at least one of search space set group information indicated by a DCI, the DCI format, the type of the uplink search space set group, the type of the downlink search space set group, and the release version configured by a higher layer signaling, and the at least one condition is associated with at least one of a budget size difference between DCI format 0-1 and DCI format 1-1, or a budget size difference between DCI format 0-2 and DCI format 1-2.

Preferably, or in some implementations, an indication indicating the type of the first group of search space sets being an uplink search space set group and/or a downlink search space set group is invalid or not presented when wireless network node does not configure the control information for the wireless terminal, and the control information includes at least one of the DCI format, the bitwidth of search space set group information indicated by the DCI, the type of the uplink search space set group, the type of the downlink search space set group, and a release version configured by a higher layer signaling.

Preferably, or in some implementations, the type of the first group of search space sets is determined based on information indicated by a DCI and/or a release version when at least one of the type of a switching search space set group, the type of an uplink search space set group, the type of a downlink search space set group and the type of a skipping search space set group is configured for the wireless terminal.

Preferably, or in some implementations, an identification of the first group of search space sets is determined based on at least one of search space set group information indicated by a DCI, the type of a switching search space set group, the type of an uplink search space set group, the type of a downlink search space set group, the type of a skipping search space set group, and a release version configured by a higher layer signaling.

Preferably, or in some implementations, the control information is associated with an indication of the minimum applicable scheduling offset.

Preferably, or in some implementations, the indication of the minimum applicable scheduling offset comprises at least one of: a DCI format, the minimum applicable value of a scheduling offset between the DCI and a physical downlink shared channel, PDSCH, scheduled by the DCI, the minimum applicable value of a scheduling offset between a slot containing the DCI triggering a set of the reference signal resources and another slot in which the set of reference signal resources is transmitted, the minimum applicable value of a scheduling offset between the DCI and a physical uplink shared channel, PUSCH, scheduled by the DCI, a value of a field indicating the minimum applicable scheduling offset, a bit width of the field indicating the minimum applicable scheduling offset, the number of values configured by a first higher layer parameter corresponding to the minimum applicable value of the scheduling offset between the DCI and the PDSCH scheduled by the DCI, or the number of values configured by a second higher layer parameter corresponding to the minimum applicable value of the scheduling offset between the DCI and the PUSCH scheduled by the DCI.

Preferably, or in some implementations, the first group of search space sets is configured as per downlink bandwidth part.

Preferably, or in some implementations, the control information is associated with at least one of a carrier indicator or a secondary cell dormancy indication in a DCI.

Preferably, or in some implementations, the transmitting, to the wireless terminal, the DCI on the PDCCH according to the first group of search space sets in the plurality of groups of search space sets based on the type of the first group of search space sets comprises not transmitting the DCI on the PDCCH according to the first group of search space sets in the cell indicated by the carrier indicator and the cells in a cell group bundled for transmitting the DCI one the PDCCH if the wireless network node configures the cell group bundled for transmitting the DCI on the PDCCH according to the first group of search space sets for the wireless terminal.

Preferably, or in some implementations, the secondary cell dormancy indication is valid for one or more groups of serving cells, and the transmitting the DCI on the PDCCH according to the first group of search space sets in the plurality of groups of search space sets based on the type of the first group of search space sets comprises transmitting the DCI on the PDCCH according to the first group of search space sets in at least one cell other than the one or more groups of serving cells supporting secondary cell dormancy behavior.

Preferably, or in some implementations, the control information is indicated by a DCI and comprises a bitmap indicating one or more cell groups where the wireless terminal monitors the PDCCH according to the first group of search space sets in the plurality of groups of search space sets.

Preferably, or in some implementations, one or more bits of the bitmap indicates a group identification of one of the plurality of groups of search space sets for the corresponding cell or cell group.

The present disclosure relates to a wireless terminal, comprising a processor, configured to monitor a physical downlink control channel, PDCCH, according to a first group of search space sets in a plurality of groups of search space sets based on a type of the first group of search space sets, wherein the first group of search space sets in the plurality of groups of search space sets is determined based on control information.

Various embodiments may preferably implement the following feature:

Preferably, or in some implementations, the processor is further configured to perform a wireless communication method of any one of foregoing recited methods.

The present disclosure relates to a wireless network node, comprising a communication unit, configured to transmit, to the wireless terminal, downlink control information, DCI, on a physical downlink control channel, PDCCH, according to a first group of search space sets in a plurality of groups of search space sets based on a type of the first group of search space sets, wherein the first group of search space sets in the plurality of groups of search space sets is determined based on control information.

Various embodiments may preferably implement the following feature:

Preferably, or in some implementations, the wireless network node further comprise a processor configured to perform a wireless communication method of any one of foregoing recited methods.

The present disclosure relates to a computer program product comprising a computer-readable program medium code stored thereupon, the code, when executed by a processor, causing the processor to implement a method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1A shows an example for PDCCH monitoring without DRX configuration.

FIG. 1B shows an example for PDCCH monitoring during DRX active time.

FIG. 2 shows an example of a schematic diagram of a wireless terminal according to an embodiment of the present disclosure.

FIG. 3 shows an example of a schematic diagram of a wireless network node according to an embodiment of the present disclosure.

FIG. 4 shows a flowchart of a method according to an embodiment of the present disclosure.

FIG. 5 shows a flowchart of a method according to an embodiment of the present disclosure.

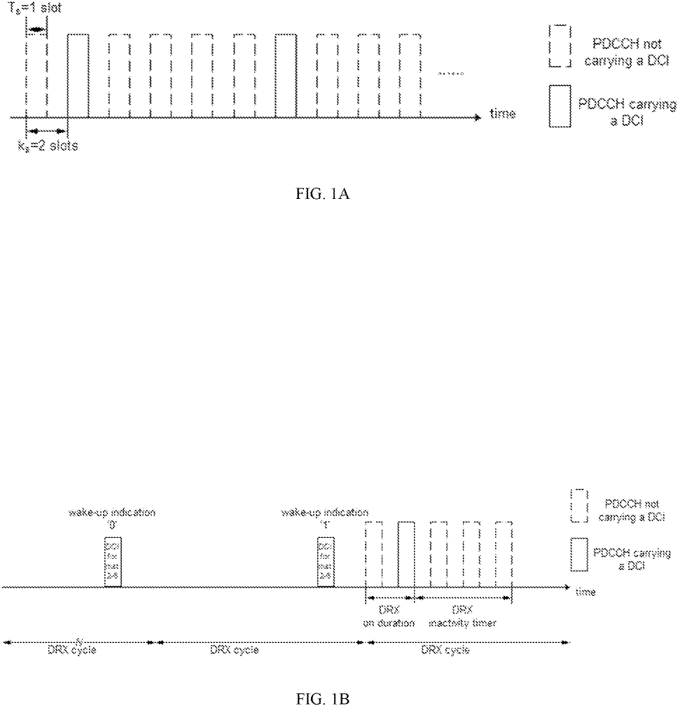

### DETAILED DESCRIPTION

In the existing long term evolution (LTE) and 5G new radio (NR) access technology communication systems, the user equipment (UE) needs to know the uplink scheduling grant information for sending physical uplink shared channel (PUSCH) and downlink scheduling allocation information for receiving physical downlink shared channel (PDSCH). The information is included in the downlink control information (DCI) and is sent by the base station to the UE on the PDCCH channel in different DCI formats. Therefore, the UE may first monitor the PDCCH.

The operations of the UE monitoring the PDCCH may be performed on the control resource set and the PDCCH monitoring occasions for a search space set. The relevant monitoring parameters of the PDCCH are included in the SearchSpace information element (IE), which is included in a radio resource control (RRC) signaling, where the searchSpaceld and the controlResourceSetId included in the SearchSpace IE indicate the search space set index and the index of CORESET applicable for this SearchSpace respectively. The searchSpaceType included in SearchSpace IE indicates the search space type of the PDCCH that the UE needs to monitor, which includes common search space and UE-specific search space corresponding to different DCI formats. The DCI format 0-0 and 1-0, DCI format 2-0, DCI format 2-1, DCI format 2-2, DCI format 2-3 are included in common search space and the DCI format 0-1 and 1-0, DCI format 0-1 and 1-1, DCI format 0-2 and/or DCI format 1-2, or DCI format 3-0 and/or 3-1 are included in UE-specific search space. For the UE supporting 3GPP release 16, the DCI formats 2-4/2-5/2-6 are also included in the common search space and the DCI formats 2-0 and 2-5 are also included in the IAB-MT specific search space (MSS).

Each DCI format has a unique usage, for example, the usages of DCI formats 0-0/0-1/0-2 include scheduling of PUSCH in one cell and the usages of DCI formats 1-0/1-1/1-2 include scheduling of PDSCH in one cell. One radio network temporary identifier (RNTI) is used to scramble the CRC (cyclic redundancy check) of DCI. The information of different functions in the DCI is identified as different fields. The fields defined in the DCI formats are mapped to the information bits α₀ to α_{A-1}. Each field is mapped in the order in which it appears in the description, including the zero-padding bit(s), if any, with the first field mapped to the lowest order information bit α₀ and each successive field mapped to higher order information bits. The most significant bit of each field is mapped to the lowest order information bit for that field, e.g. the most significant bit of the first field is mapped to α₀.

The duration included in the SearchSpace IE is a duration of Tₛ < kₛ indicating the number of slots that the UE monitors PDCCH for search space set s; monitoringSlotPeriodicityAndOffset included in the SearchSpace IE indicates a PDCCH monitoring periodicity of kₛ slots and a PDCCH monitoring offset of oₛ slots; monitoringSymbolsWithinSlot N_{symb} included in the SearchSpace IE indicates the first symbol(s) for PDCCH monitoring within a slot for PDCCH monitoring.

For the bit-mapping indication of the parameter monitoringSymbolsWithinSlot, the most significant (left) bit represents the first OFDM in a slot, and the second most significant (left) bit represents the second OFDM symbol in a slot and so on. The bit(s) set to one identify the first OFDM symbol(s) of the control resource set within a slot. For example, for DCI format 2_0, the first symbol applies if the duration of CORESET (in the IE ControlResourceSet) identified by controlResourceSetld indicates 3 symbols, the first two symbols apply if the duration of CORESET identified by controlResourceSetld indicates 2 symbols, and the first three symbols apply if the duration of CORESET identified by controlResourceSetld indicates 1 symbol.

If the monitoringSymbolsWithinSlot indicates to a UE to monitor PDCCH in a subset of up to three consecutive symbols that are the same in every slot where the UE monitors PDCCH for all search space sets, the UE is not expected to be configured with a PDCCH subcarrier spacing (SCS) other than 15 kHz when the subset includes at least one symbol after the third symbol. A UE is not expected to be provided a first symbol and the number of consecutive symbols for a control resource set (CORESET) that results in a PDCCH candidate mapping to symbols of different slots. A UE does not expect any two PDCCH monitoring occasions (MOs) on an active DL BWP, for the same search space set or for different search space sets, in the same CORESET to be separated by a non-zero number of symbols that is smaller than the CORESET duration.

The specific PDCCH monitoring occasion(s) can be obtained as follows. For search space set s, the UE determines that a PDCCH monitoring occasion(s) exists in a slot with number

$${n}_{s , f}^{μ}$$

in a frame with number

$${n}_{f} \text{if} \left({n}_{f} ⋅ {N}_{s l o t}^{f r a m e , μ} + {n}_{s , f}^{μ} - {o}_{s}\right) m o d {k}_{s} = 0.$$

The UE monitors PDCCH for search space set s for Tₛ consecutive slots, starting from slot

$${n}_{s , f}^{μ} ,$$

and does not monitor PDCCH for search space set s for the next kₛ-Tₛ consecutive slots.

When a DRX cycle is configured, the active time for serving cells in a DRX group includes the time while:
drx-onDurationTimer or drx-InactivityTimer configured for the DRX group is running; or
drx-RetransmissionTimerDL or drx-RetransmissionTimerUL is running on any serving cell in the DRX group; or
ra-ContentionResolutionTimer or msgB-Response Window is running; or
a scheduling request is sent on PUCCH and is pending; or
a PDCCH indicating a new transmission addressed to the C-RNTI of the MAC entity has not been received after successful reception of a random access response for the random access preamble not selected by the MAC entity among the contention-based random access preamble.

Serving cells may be configured by RRC in two groups. When RRC does not configure a secondary DRX group, there is only one DRX group. When two DRX groups are configured, each group of serving cells, which is called a DRX group, is configured by RRC with its own set of parameters: drx-onDurationTimer, drx-InactivityTimer. When two DRX groups are configured, the two groups share the following parameter values: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

The MAC entity may be configured by RRC with a DRX functionality that controls the UE’s PDCCH monitoring activity for the MAC entity’s C-RNTI, CI-RNTI, CS-RNTI, INT-RNTI, SFI-RNTI, SP-CSI-RNTI, TPC-PUCCH-RNTI, TPC-PUSCH-RNTI, and TPC-SRS-RNTI. When using DRX operation, the MAC entity may also monitor PDCCH according to requirements. When in RRC_CONNECTED, if DRX is configured, for all the activated serving cells, the MAC entity may monitor the PDCCH discontinuously using the DRX operation; otherwise the MAC entity may monitor the PDCCH.

Power saving techniques for 5G NR are exemplified in the following:

1) Wake-up indication indicated by DCI format 2-6 can indicate (e.g. instruct) a UE to or not to wake up in the next long DRX cycle. The physical layer of the UE shall send the value to the MAC layer (e.g. higher layer) to determine whether to start or not to start the drx-onDuration timer in the next long DRX cycle.

2) Minimum applicable scheduling offset indication indicated by DCI format 0-1/1-1 can be used to determine the minimum applicable K2 for the active UL BWP, the minimum applicable K0 value for the active DL BWP and the minimum applicable value of the aperiodic CSI-RS triggering offset for an active DL BWP. Wherein the minimum K2 parameter denotes the minimum applicable value(s) for the Time domain resource assignment (TDRA) table for PUSCH and the minimum K0 parameter denotes minimum applicable value(s) for the TDRA table for PDSCH and for A-CSI RS triggering offset(s). Note that, the value of K2 represents the slot offset between DCI and its scheduled PUSCH and the value of K0 represents the slot offset between DCI and its scheduled PDSCH. In addition, the value of A-CSI RS triggering offset(s) represents the offset between the slot containing the DCI that triggers a set of aperiodic NZP CSI-RS resources and the slot in which the CSI-RS resource set is transmitted. It makes UE relax the PDCCH decoding process time to reduce some decoding power consumption.

3) The indication of dormancy-like behavior transition on SCell(s) indicated by DCI format 2-6/0-1/1-1 can trigger UE to perform dormancy behavior on some SCells. If the UE is indicated by a value of “0” for the activated SCell in the corresponding group of configured SCells, the UE may switch from the non-dormant BWP to the dormant BWP for the SCell. Otherwise, if the UE is indicated by a value of “1” and a current active DL BWP is the dormant DL BWP, the UE may switch from the dormant BWP to the non-dormant BWP for the SCell. The dormant BWP and the non-dormant BWP are configured by high layer parameter.

4) The search space set switching indication indicated by DCI format 2-0 can indicate a group from two groups of search space sets for PDCCH monitoring for scheduling on the serving cell. The UE can monitor PDCCH according to the search space sets with the indicated group index.

In the following, the PDCCH monitoring periodicity kₛ is also called the PDCCH monitoring cycle. The number of the monitoring occasions (MOs) within a slot for PDCCH monitoring is referred to as N_{MO}. Wherein the number of available PDCCH monitoring occasions within a slot (N_{symb}) is determined by the configured monitoringSymbolsWithinSlot, the CORESET duration and one or more search space sets associated with the CORESET.

In the present disclosure, PDCCH monitoring behavior represents at least one of the following behaviors: 1) monitoring PDCCH according to a search space set by a UE, 2) monitoring PDCCH according to search space sets within a group by a UE, 3) monitoring PDCCH according to a portion of search space sets in a search space set group by a UE, 4) monitoring PDCCH according to a list of parameters related to PDCCH monitoring by a UE.

In the present disclosure, PDCCH monitoring behavior transition represents the functionality including at least one of the followings: 1) switching to monitor PDCCH according to another search space set, 2) switching to monitor PDCCH according to another group of search space sets, 3) switching to monitor PDCCH according to another list of parameters related to PDCCH monitoring, 4) switching to monitor PDCCH according to another portion of search space sets in a search space set group, 5) switching to monitor PDCCH according to another PDCCH monitoring configuration triggered by another behavior. Wherein “another behavior” may relate to the minimum applicable scheduling offset indication, carrier indicator, SCell dormancy indication, and/or the wake-up indication, etc.

In the present disclosure, the search space set group switching capability may represent at least one of the followings: 1) the number of search space set groups and/or the search space set group ID configured for the UE; 2) the UE capability of search space set group switching.

In the present disclosure, the high-layer parameter represents the radio resource control (RRC) signaling. The higher-layer parameter represents the medium access control (MAC) signaling or the RRC signaling. The L1 signaling represents the physical signaling or the downlink control signaling, e.g. a DCI carried by PDCCH.

In some embodiments, the UE may be indicated to monitor PDCCH according to search space sets in a search space set group. In some embodiments, the number of search space set groups is N. In some embodiments, N is not smaller than 1 and is not larger than 10. In some embodiments, each search space set group has its own group identity (ID). In some embodiments, the number of search space set in a search space set group is not smaller than 1 and not larger than the maximum number of search space set group.

In the following, n bits search space set group switching field combined with 1 bit cross-slot scheduling indication according to an embodiment is described.

In some embodiments, the search space set group ID can be indicated by a search space set group switching field in DCI format 0-1 and/or DCI format 1-1 and/or DCI format 0-2 and/or DCI format 1-2.

In some embodiments, the bitwidth of the search space set group switching field can be 0 or n if the UE supports search space set group switching capability.

In some embodiments, n is determined based on the maximum number of search space set groups and/or the parameters related to minimum applicable scheduling offset indication.

In some embodiments, the parameters related to minimum applicable scheduling offset indication include at least one of the following: a) the bitwidth of the “minimum applicable scheduling offset indicator” field; b) the higher layer parameters minimumSchedulingOffsetK0 and/or minimumSchedulingOffsetK2.

In some embodiments, n is equal to ƒunc(log2(N)) if the bitwidth of the “minimum applicable scheduling offset indicator” field is equal to 0 and/or the “minimum applicable scheduling offset indicator” field is not used to determine the search space set group ID.

In some embodiments, n is equal to ƒunc(log2(N))-1 if the bitwidth of the “minimum applicable scheduling offset indicator” field is not equal to 0 and/or the “minimum applicable scheduling offset indicator” field is used to determine the search space set group ID. Wherein the ƒunc(•) represents rounding, rounding down, rounding up or retaining the original value of “•”.

In some embodiments, the search space set group ID may be determined based on the minimum applicable scheduling offset indication and the indication of search space set group switching field.

In some embodiments, if the UE supports search space set group switching capability the bitwidth of the search space set group switching field in DCI format 0-1/1-1 and/or DCI format 0-2/1-2 is not equal to 0.

In some embodiments, if the UE supports search space set group switching capability and the “minimum applicable scheduling offset indicator” field is also used to indicate the search space set group switching and the bitwidth of the “minimum applicable scheduling offset indicator” field is not equal to 0, the search space set group ID may be determined by the combination of the bit field of the search space set group switching field and the “minimum applicable scheduling offset indicator” field.

In some embodiments, the bit field of the “minimum applicable scheduling offset indicator” field represents the MSB of the search space set group ID and the bit field of the search space set group switching represents the LSB of the search space set group ID and vice versa.

In some embodiments, if the search space set group switching is configured to be used for the active DL BWP, the “minimum applicable scheduling offset indicator” field may be used to indicate the search space set group switching.

In some embodiments, if the search space set group switching capability is not configured for the UE, the “minimum applicable scheduling offset indicator” field is not used to indicate the search space set group switching.

In some embodiments, if the search space set group switching capability is configured to be used for the serving cell or serving cell group, the “minimum applicable scheduling offset indicator” field is not used to indicate the search space set group switching.

Next, search space set group switching bundled with the different cases of cross-slot scheduling indication according to an embodiment is described.

In some embodiments, the search space set group ID can be determined based on the cases of minimum applicable scheduling offset indication.

In some embodiments, the cases of minimum applicable scheduling offset indication include at least one of the following: 1) the DCI format used to indicate minimum applicable scheduling offset; 2) the value of K0min/aperiodic CSI-RS triggering offset and/or K2min determined by the indication of a DCI; 3) the value of the “minimum applicable scheduling offset indicator” field indicated by DCI; 4) the bitwidth of the “minimum applicable scheduling offset indicator” field; 5) the number of values configured by minimumSchedulingOffsetK0 and/or minimumSchedulingOffsetK2; 6) the search space set group switching supported by the UE is used for the active DL BWP. Wherein minimumSchedulingOffsetK0 and minimumSchedulingOffsetK2 are the higher layer parameters.

In some embodiments, the above cases 3), 4) and 5) of minimum applicable scheduling offset indication also include at least one of the following conditions: 1) the bitwidth of the “minimum applicable scheduling offset indicator” field is equal to 0; 2) the bitwidth of the “minimum applicable scheduling offset indicator” field is not equal to 0 and the bit field is equal to 0; 3) the bitwidth of the “minimum applicable scheduling offset indicator” field is not equal to 0 and the bit field is equal to 1; 4) the bitwidth of the “minimum applicable scheduling offset indicator” field is not equal to 0 and the bit field is equal to 1, and minimumSchedulingOffsetK0 and minimumSchedulingOffsetK2 only configure one value for the active DL BWP; 5) the bitwidth of the “minimum applicable scheduling offset indicator” field is not equal to 0 and the bit field is equal to 1, and minimumSchedulingOffsetK0 and minimumSchedulingOffsetK2 configure two values for the active DL BWP; 6) the bitwidth of the “minimum applicable scheduling offset indicator” field is not equal to 0 and the bit field is equal to 1, and K0min and/or K2min is equal to 0; 7) the bitwidth of the “minimum applicable scheduling offset indicator” field is not equal to 0 and the bit field is equal to 1, and K0min and/or K2min is not equal to 0.

In some embodiments, if the search space set group ID determined by the cases of minimum applicable scheduling offset indication is different from the current search space set group ID, the UE may stop monitoring PDCCH according to the search space sets in the current search space set group and start monitoring PDCCH according to the search space sets in the determined search space set group when one or more specific conditions are met.

In some embodiments, the specific conditions include at least one of the followings: 1) the UE supports search space set group switching capability; 2) the search space set group ID is configured for the active DL BWP and/or the serving cell; 3) the serving cell where UE receives the DCI carrying search space set group ID indication is included in the cell group which bundles a list of serving cells for search space set group switching purpose; 4) the current slot is the first slot after a number of symbols after receiving the DCI triggering search space set group switching; 5) the higher layer parameter minimumSchedulingOffsetK0 and/or minimumSchedulingOffsetK2 is configured for the UE.

According to a first example, if the UE supports search space set group switching, the bitwidth of the search space set group indication field in DCI format 0-1 and/or DCI format 1-1 and/or DCI format 0-2 and/or DCI format 1-2 is not equal to 0. If the number of search space set group configured for the UE is equal to 8 and the “minimum applicable scheduling offset indicator” field is configured to be used to indicate search space set group switching, the value of the bit field of the “minimum applicable scheduling offset indicator” field in different DCI formats for the UE may indicate different search space set group IDs, i.e. the values “0” and “1” of the bit field indicated by DCI format 0-1 indicate search space set group IDs 0 and 1, respectively, and the values “0” and “1” of the bit field indicated by DCI format 1-1 indicates search space set group IDs 2 and 3, respectively, and the values “0” and “1” of the bit field indicated by DCI format 0-2 indicate search space set group IDs 4 and 5, respectively, and the values “0” and “1” of the bit field indicated by DCI format 1-2 indicate search space set group IDs 6 and 7, respectively.

If the bitwidth of the “minimum applicable scheduling offset indicator” field is 0 bit and the UE supports search space set group switching, the search space set group ID may be indicated by or determined by the value of the search space set group switching field indicated by DCI format 0-1 and/or DCI format 1-1 and/or DCI format 0-2 and/or DCI format 1-2.

If the UE does not support search space set group switching, the values of the bit field of the “minimum applicable scheduling offset indicator” field in different DCI formats for the UE are not used to indicate search space set group IDs.

Next, decoupling DL/UL search space set group switching bundled with cross-slot scheduling according to an embodiment is described.

In some embodiments, a search space set configured for the active DL BWP for the UE may belong to an uplink (UL) search space set group and a downlink (DL) search space set group. In some embodiments, if the UE supports decoupling PDCCH monitoring for UL and DL scheduling, the search space set group may be configured as UL search space set group and DL search space set group separately. Wherein the UE monitors PDCCH carrying DCI or blind decodes DCI for UL scheduling according to search space sets in a UL search space set group indicated by a first type of DCI format. Wherein the UE monitors PDCCH carrying DCI or blind decodes DCI for DL scheduling according to search space sets in a DL search space set group indicated by a second type of DCI format.

In some embodiments, the first type of DCI format is included in the second type of DCI format. In some embodiments, the second type of DCI format includes DCI format 0-1 and/or DCI format 0-2 and/or DCI format 1-1 and/or DCI format 1-2 scrambled by C-RNTI, or CS-RNTI, or MCS-C-RNTI.

In some embodiments, the first type of DCI format is different from the second type of DCI format. In some embodiments, the first type of DCI format includes DCI format 0-1 and/or DCI format 0-2 scrambled by C-RNTI, or CS-RNTI, or MCS-C-RNTI. In some embodiments, the second type of DCI format includes DCI format 1-1 and/or DCI format 1-2 scrambled by C-RNTI, or CS-RNTI, or MCS-C-RNTI.

In some embodiments, if the UE supports decoupling PDCCH monitoring for UL and DL scheduling, the search space set group may be configured as UL search space set group and DL search space set group separately.

In some embodiments, the UE monitors PDCCH carrying DCI or blind decodes DCI for UL scheduling according to search space sets in a UL search space set group. In some embodiments, the UE monitors PDCCH carrying DCI or blind decodes DCI for DL scheduling according to search space sets in a DL search space set group. In some embodiments, the UL and DL search space set group switching are triggered by the cases of minimum applicable scheduling offset indication. Wherein the cases of the minimum applicable scheduling offset indication are described above and referred to at this point.

In some embodiments, a UL and/or DL search space set group is/are determined based on at least one of the control information or at least one condition. In some embodiments, the control information includes at least one of search space set group information indicated by a DCI, the DCI format, the type of the uplink search space set group, the type of the downlink search space set group, and the release version configured by a higher layer signaling, and the cases of minimum applicable scheduling offset indication described in the above embodiments. In some embodiments, the at least one condition is associated with at least one of a budget size difference between DCI format 0-1 and DCI format 1-1, or a budget size difference between DCI format 0-2 and DCI format 1-2.

For example, for the UE supports search space set group switching, when the uplink search space set group is configured for the UE by higher layer signaling, the DCI format 0-1 can indicate the ID of an uplink search space set group and/or a downlink search space set group. For the UE supports search space set group switching, when the downlink search space set group is configured for the UE by higher layer signaling, the DCI format 1-1 can indicate the ID of an uplink search space set group and/or a downlink search space set group.

For example, when the budget size difference between DCI format 0-1 and DCI format 1-1, or the budget size difference between DCI format 0-2 and DCI format 1-2 is not equal to 0, the UE is available to monitor PDCCH according to the search space sets in an UL search space set group or a DL search space set group if the control information indicates an UL search space set group and/or a DL search space set group for the UE.

In some embodiments, the indication indicating a group of search space sets being an uplink search space set group and/or a downlink search space set group is invalid or not presented when the control information is not configured for the UE. In some embodiments, the control information includes at least one of the DCI format, the bitwidth of search space set group information indicated by the DCI, the type of the uplink search space set group, the type of the downlink search space set group, and a release version configured by a higher layer signaling, and the cases of minimum applicable scheduling offset indication described in the above embodiments.

In some embodiments, if the UE supports decoupling PDCCH monitoring for UL and DL scheduling, the search space set group can be configured as UL search space set group and DL search space set group separately.

In some embodiments, the UE monitors PDCCH carrying DCI or blind decodes DCI for UL scheduling according to search space sets in a UL search space set group. In some embodiments, the UE monitors PDCCH carrying DCI or blind decodes DCI for DL scheduling according to search space sets in a DL search space set group. In some embodiments, the UL and DL search space set group switching are triggered by the value of bit field of the “minimum applicable scheduling offset indicator” field.

In some embodiments, the UL search space set group ID and DL search space set group ID can be indicated or determined by the indication of the “minimum applicable scheduling offset indicator” field in the same DCI corresponding to DCI format 0-1 and/or DCI format 1-1 and/or DCI format 0-2 and/or DCI format 1-2.

In some embodiments, the UL search space set group ID may be indicated or determined by the “minimum applicable scheduling offset indicator” field indicated by DCI format 0-1. In some embodiments, the DL search space set group ID may be indicated or determined by the “minimum applicable scheduling offset indicator” field indicated by DCI format 1-1.

Next, search space set group switching indication and SCell dormancy indication/carrier indicator according to an embodiment is described.

In some embodiments, one serving cell cannot be configured in both the cell group used for dormancy behavior indication and the cell group used for search space set group switching purpose. In some embodiments, if a serving cell is configured with a dormant BWP within DRX active time, the serving cell cannot be configured in a cell group used for search space set group switching. In some embodiments, if the bitwidth of the “SCell dormancy indication” field in a DCI is not equal to 0 and/or the SCell dormancy indication by a DCI is valid for the UE, the search space group may be ignored by the UE.

In some embodiments, if the carrier indicator indicated by a DCI is not equal to 0 and the DCI can indicate the search space set group ID, the indication of search space set group ID indicated by the DCI may be ignored by the UE.

In some embodiments, if the carrier indicator indicated by a DCI is not equal to 0, and a group of serving cells is configured being bundled to monitor PDCCH according to a group of search space sets with a same group ID in their DL active BWPs respectively, the indication of search space set group ID indicated by the DCI may be ignored by the UE.

In some embodiments, if the carrier indicator indicated by a DCI is not equal to 0, and the search space set group ID is indicated by the DCI, the UE may monitor PDCCH according to the group of search space sets with the group ID in the active DL BWP in primary cell and/or primary secondary cell.

In some embodiments, if the carrier indicator indicated by DCI format 0-1/1-1/0-2/1-2 is not equal to 0, the search space set group switching indicated by the DCI can be used for the primary cell for a UE.

In some embodiments, if the carrier indicator indicated by DCI format 0-1/1-1/0-2/1-2 in a serving cell received by the UE is not equal to 0 and the serving cell is included in a cell group used for search space set group switching purpose, the search space set group switching indication may be ignored by the UE.

In some embodiments, if the carrier indicator indicated by DCI format 0-1/1-1/0-2/1-2 in a serving cell received by the UE is not equal to 0 and the serving cell is included in a cell group used for search space set group switching purpose, the search space set group switching indicated by the DCI may only be used for the serving cell where the UE receives the DCI.

In some embodiments, if the carrier indicator indicated by DCI format 0-1/1-1/0-2/1-2 in a serving cell received by the UE is not present or equal to 0 and the serving cell is included in a cell group used for search space set group switching purpose, the search space set group switching indicated by the DCI may be used for each serving cell in the configured cell group including the serving cell where the UE receives the DCI.

Next, it is described that field(s) used for SCell dormancy indication may be used to indicate SS set group switching in accordance with some embodiments.

In some embodiments, if the bit field of the carrier indicator of DCI format 0-1/1-1 is equal to 0 and the bitwidth of the “SCell dormancy indication” field is not equal to 0, the bit value of the “SCell dormancy indication” field may be used to indicate search space set group switching.

In some embodiments, if the bit field of carrier indicator of DCI format 0-1 and 1-1 is equal to 0 and the bitwidth of the “SCell dormancy indication” field is not equal to 0, the bit value of the “SCell dormancy indication” field in DCI format 0-1/1-1 is used to indicate UL and DL search space set group switching if the UE supports decoupling PDCCH monitoring for UL and DL scheduling.

In some embodiments, if the bit field of carrier indicator of DCI format 0-1 and 1-1 is equal to 0 and the bitwidth of the “SCell dormancy indication” field is not equal to 0, the bit value of the “SCell dormancy indication” field in DCI format 0-1 and 1-1 is used to indicate UL and DL search space set group switching, respectively, if the UE supports decoupling PDCCH monitoring for UL and DL scheduling.

In some embodiments, if the “SCell dormancy indication field” is reserved and the following fields are used for SCell dormancy indication in DCI format 1-1 and the carrier indicator is not equal to 0, the following fields may be used to indicate the search space set group switching:
Modulation and coding scheme of transport block 1;
New data indicator of transport block 1;
Redundancy version of transport block 1;
HARQ process number;
Antenna port(s);
DMRS sequence initialization.

Next, search space set group switching and skipping according to an embodiment is described.

In the following, search space set group skipping means that the UE may skip PDCCH monitoring according to search space set(s) in a search space set group during a time duration.

In some embodiments, the search space set group for skipping includes all search space sets configured for the active DL BWP or the serving cell or the serving cell group. In some embodiments, search space set group skipping is similar to PDCCH skipping.

In some embodiments, if the UE supports search space set group switching capability, the UE may be indicated by a DCI to perform search space set group switching. In some embodiments, if the UE supports search space set group skipping capability and does not support search space set group switching capability, the UE may be indicated by a DCI to perform search space set group skipping.

In some embodiments, if the UE supports search space set group skipping capability and search space set group switching capability, the search space set group skipping and search space set switching may be indicated by the same DCI format.

Next, different types of PDCCH monitoring behavior according to a group of search space sets and the corresponding types of search space set group according to an embodiment is described.

In some embodiments, the search space set group ID for one or more types of search space set group can be the same. In some embodiments, a search space set ID can be configured in the search space group with the same group ID for one or more types of search space set group.

In some embodiments, the search space set group ID for one or more types of search space set group can be the same. In some embodiments, a search space set ID can be configured in the search space group with the different group ID for one or more types of search space set group.

In some embodiments, switching the PDCCH monitoring according to a group of search space sets among all of the search space set group IDs or the types of search space set group is configured as per DL BWP. In some embodiments, switching the PDCCH monitoring according to a group of search space sets among all of the search space set groups or the types of search space set group is used for per DL BWP.

In some embodiments, the UE can perform one or more types of PDCCH monitoring behavior according to a group of search space sets. In some embodiments, if at least one of the search space sets in the DL active BWP for the UE is configured to support at least two types of search space set groups, the UE can switch PDCCH monitoring behavior according to a group of search space sets. The at least two types of search space set groups comprise at least one of the switching search space set group, the skipping search space set group, the uplink search space set group or the downlink search space set group.

In some embodiments, the PDCCH monitoring behavior according to the switching search space set group comprises monitoring PDCCH for detection of one or more DCI formats according to the configurations in each search space set of the search space set group. In some embodiments, the PDCCH monitoring behavior according to the skipping search space set group comprises stop monitoring PDCCH for detection of one or more DCI formats according to the group of search space sets. In some embodiments, the PDCCH monitoring behavior according to the uplink search space set group comprises monitoring PDCCH for detection of one or more DCI formats used for scheduling UL transmission according to the group of search space sets. In some embodiments, the PDCCH monitoring behavior according to the downlink search space set group comprises monitoring PDCCH for detection of one or more DCI formats used for scheduling DL transmission according to the group of search space sets.

For example, when the skipping search space set group and the switching search space set group are configured for one or more search space sets in the active DL BWP for the UE, the UE may switch PDCCH monitoring behavior from monitoring PDCCH according to a group of search space sets into stop monitoring PDCCH according to the other group of search space sets if the control information including DCI and/or the higher layer signaling triggers the change of the type of search space set group and/or a search space set group ID.

In some embodiments, the group ID of the group of search space sets can be the same as the group ID of the other group of search space sets.

For example, when the uplink search space set group and the downlink search space set group are configured for one or more search space sets in the active DL BWP for the UE, the UE may switch PDCCH monitoring behavior from monitoring PDCCH according to an uplink group of search space sets into monitoring PDCCH according to downlink group of search space sets if the control information including DCI and/or the higher layer signaling triggers the change of the type of search space set group and/or a search space set group ID.

In some embodiments, the group ID of the uplink group of search space sets can be the same as the group ID of the downlink group of search space sets.

For example, when the switching search space set group, the uplink search space set group and the downlink search space set group are configured for one or more search space sets in the active DL BWP for the UE, the UE may switch PDCCH monitoring behavior from monitoring PDCCH according to a group of search space sets into monitoring PDCCH according to downlink group of search space sets and/or an uplink group of search space sets if the control information including DCI and/or the higher layer signaling triggers the change of the type of search space set group to the type of uplink and/or downlink search space set group, and/or an uplink search space set group ID and/or an downlink search space set group ID.

In some embodiments, the group ID of the group of search space sets can be the same as the group ID of the downlink group of search space sets or the uplink group of search space sets.

In some embodiments, when the uplink search space set group and the downlink search space set group are configured for one or more search space sets in the active DL BWP for the UE, if there is no control information triggering the uplink search space set group and/or the downlink search space set group, the UE may perform PDCCH monitoring behavior corresponding to the type of switching search space set group according to the group of search space sets.

In some embodiments, the type of the search space set group can be determined by the indication of a DCI and/or the configuration of the higher layer signaling. In some embodiments, the indication of the type of the search space set group is associated with at least one of the following: 1) the DCI format used to indicate minimum applicable scheduling offset; 2) the value of K0min/aperiodic CSI-RS triggering offset and/or K2min determined by the indication of a DCI; 3) the value of ‘minimum applicable scheduling offset indicator’ field indicated by DCI; 4) the bitwidth of the ‘minimum applicable scheduling offset indicator’ field; 5) the number of values configured by minimumSchedulingOffsetK0 and/or minimumSchedulingOffsetK2; 6) the search space set group switching supported by the UE is used for the active DL BWP. Note that, minimumSchedulingOffsetK0 and minimumSchedulingOffsetK2 are the higher layer parameters.

For example, the higher layer parameter minimumSchedulingOffsetK0 is configured and the value of ‘minimum applicable scheduling offset indicator’ field can be used to determine any two types of the switching search space set group, skipping search space set group and downlink search space set group.

For example, the higher layer parameter minimumSchedulingOffsetK2 is configured and the value of ‘minimum applicable scheduling offset indicator’ field can be used to determine any two types of the switching search space set group, skipping search space set group and uplink search space set group.

In some embodiments, both the type of the search space set group and the search space set group ID are indicated by the indication of a DCI and/or the configuration of the higher layer signaling.

In some embodiments, the type of the search space set group and the search space set group ID are indicated by the same field of a DCI.

In some embodiments, the type of the search space set group is configured by one or more higher layer parameters, and the search space set group ID are indicated by a DCI and the one or more higher layer parameters.

In some embodiments, the capability of monitoring PDCCH including at least one of PDCCH monitoring switching between at least two groups of search space sets, skipping PDCCH monitoring according to a skipping search space set group, PDCCH monitoring for detection of one or more DCI formats scheduling uplink transmission according to an uplink search space set group, and PDCCH monitoring for detection of one or more DCI formats scheduling downlink transmission according to a downlink search space set group belongs to a higher layer signaling. The higher layer signaling is the UE feature and/or UE capability.

In some embodiments, the UE capability includes at least one of PDCCH monitoring switching between at least two groups of search space sets, skipping PDCCH monitoring according to a skipping search space set group, PDCCH monitoring for detection of one or more DCI formats scheduling uplink transmission according to an uplink search space set group, or PDCCH monitoring for detection of one or more DCI formats scheduling downlink transmission according to a downlink search space set group that can be enabled for the UE if the UE supports a release version 17 or the future release versions configured by a higher layer parameter. In some embodiments, the UE capability includes at least one of skipping PDCCH monitoring according to a skipping search space set group, PDCCH monitoring for detection of one or more DCI formats scheduling uplink transmission according to an uplink search space set group, or PDCCH monitoring for detection of one or more DCI formats scheduling downlink transmission according to a downlink search space set group that is not supported by the UE if the UE supports a release version 16 or the former release versions (e.g. release version 15) configured by a higher layer parameter.

In some embodiments, for the UE supports UE capabilities associated with at least one of the types of search space set group, a search space set can be configured P types of search space set group. Wherein each type of search space set group can be configured Q group IDs. In some embodiments, P is not smaller than 0 and is not larger than 3. In some embodiments, Q is not smaller than 2 and is not larger than 10.

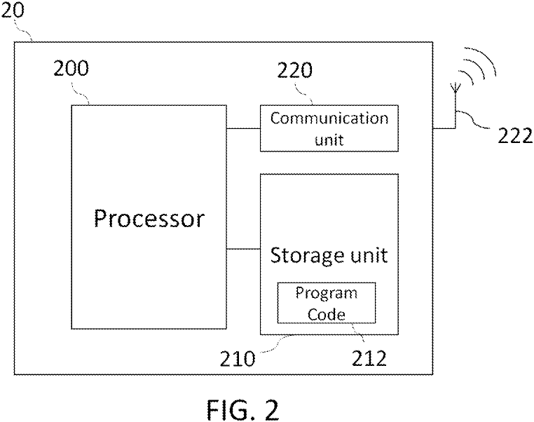

FIG. 2 relates to a schematic diagram of a wireless terminal 20 in an embodiment of the present disclosure. The wireless terminal 20 may be a communication device, a user equipment (UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 210 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g. messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g. a base station).

In an embodiment, the UE supports switching PDCCH monitoring among one or more search space set groups, wherein the number of search space set groups is equal to N. In an embodiment, N is an integer not smaller than 1 and not larger than 10.

In an embodiment, the PDCCH monitoring for UL and DL scheduling may be decoupled. More specifically, one search space set can be included in a UL search space set group and/or a DL search space set group. The UE can blind decode DCI for indicating transmission in PUCCH/PUSCH according to search space sets in the UL search space set group. In addition, the UE can blind decode DCI for indicating transmission in PDSCH according to search space sets in the DL search space set group.

In an embodiment, a search space set can include at least one of the following parameters: 1) the search space set group ID; 2) the UL search space set group ID; 3) the DL search space set group ID; 4) the search space set group for skipping; 5) a skipping period. If the UE supports a search space set group for skipping, the UE may stop PDCCH monitoring according to the search space sets in the indicated/triggered search space set group (i.e. the search space set group for skipping) during the skipping period, wherein the skipping period may be configured for a (an active) DL BWP and/or a search space set and/or a search space set group and/or a cell group bundled for search space set group switching. Wherein the skipping period is not smaller than 0 and the unit of the skipping period is slot or millisecond.

In an embodiment, the search space set group ID can be indicated or determined based on a plurality of parameters.

In an embodiment, the plurality of parameters used to indicate or determine the search space set group ID is related to minimum applicable scheduling offset indication. For example, the plurality of parameters includes at least one of the followings: 1) the DCI format used to indicate minimum applicable scheduling offset; 2) the value of K0min/aperiodic CSI-RS triggering offset and/or K2min determined by the indication of a DCI; 3) the value of ‘minimum applicable scheduling offset indicator’ field indicated by DCI; 4) the bitwidth of the ‘minimum applicable scheduling offset indicator’ field; 5) the number of values configured by minimumSchedulingOffsetK0 and/or minimumSchedulingOffsetK2; 6) the search space set group switching supported by the UE is used for the active DL BWP. Note that, minimumSchedulingOffsetK0 and minimumSchedulingOffsetK2 are the higher layer parameters.

In an embodiment, the plurality of parameters used to indicate or determine the search space set group ID is related to the carrier indicator and/or the SCell dormancy indication of a DCI.

In an embodiment, if carrier indicator indicated by a DCI is not equal to 0, the UE shall ignore the search space set group switching indication for a group of serving cells.

In an embodiment, if a dormant BWP is configured in a serving cell, the serving cell cannot be configured in a serving cell group bundled for search space set group switching purpose.

In an embodiment, if the UE supports search space set group skipping, the UE may be indicated to stop PDCCH monitoring according to the search space sets in a search space set group. The search space set group ID can be indicated by a DCI. For a search space set group for PDCCH skipping, a duration shall be configured for each search space set in the search space set group for PDCCH skipping. The UE can stop PDCCH monitoring during the corresponding duration.

In an embodiment, a bitmap can be used to indicate a list of cell group of performing search space set group switching. For example, every adjacent n bits of the bitmap may indicate a search space set group ID for a cell group, wherein all of cells in a cell group are bundled for a search space set group switching.

In an embodiment, the UL search space set group and DL search space set group can be indicated by the same DCI. If the UE supports UL search space set group switching, a field can be used to indicate UL search space set group ID in a DCI. If the UE supports DL search space set group switching, a field can be used to indicate DL search space set group ID in a DCI.

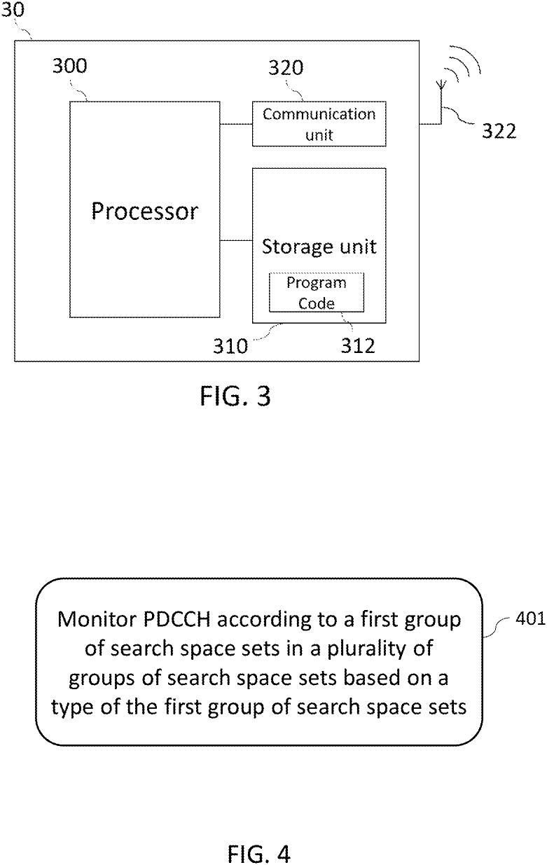

FIG. 3 relates to a schematic diagram of a wireless network node 30 in an embodiment of the present disclosure. The wireless network node 30 may be a communication device, a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless network node 30 may comprise (perform) at least one network function such as an access and mobility management function (AMF), a session management function (SMF), a user plane function (UPF), a policy control function (PCF), an application function (AF), an application protocol client function, an application protocol server function, a port management registration and allocation function, a port allocation function, etc. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 310 include but are not limited to a SIM, ROM, flash memory, RAM, hard-disk, and optical data storage device. The communication unit 320 may be a transceiver and is used to transmit and receive signals (e.g. messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g. a user equipment).

FIG. 4 shows a flowchart of a process according to an embodiment of the present disclosure. The process shown in FIG. 4 may be used in a wireless terminal (e.g. UE) and comprises the following step:

Step 401: Monitor PDCCH according to a first group of search space sets in a plurality of groups of search space sets based on a type of the first group of search space sets.

In FIG. 4, the wireless terminal monitors PDCCH according to a first group of search space sets in a plurality of groups of search space sets based on a type of the first group of search space sets. More specifically, the wireless terminal supports search space group switch(ing). That is, the wireless terminal may change (e.g. switch) the group of search space sets used associated with monitoring the PDCCH, e.g. when receiving corresponding indication (e.g. search space group switch indication). For example, the wireless terminal may monitor the PDCCH according to one of the plurality of the groups of search space sets (i.e. the first group of search space sets). Note that, the first group of search space sets in the plurality of groups of search space sets is determined based on control information. In this embodiment, the behavior of the wireless terminal monitoring the PDCCH may change based on the type of the first group of search space sets. In some embodiments, the control information may comprise at least one of higher layer signaling or predefined condition(s).

In an embodiment, the first group of search space sets is a search space set group with a group ID. The search space sets of the first group of search space sets have the same group ID configured by the higher layer signaling. The type of the first group of search space sets corresponds to a specific PDCCH monitoring behavior according to the group of search space sets and/or a configuration of higher layer parameter for a search space set or a group of search space sets. The specific PDCCH monitoring behavior comprises at least one of the behavior of monitoring the PDCCH according to the uplink search space set group, or the downlink search space set group, or the switching search space set group, or the skipping search space set group. In addition, the monitoring the PDCCH according to the switching search space set group comprises monitoring the PDCCH for the detection of one or more DCI formats according to all of the configurations of the group of search space sets.

In an embodiment, the type of the first group of search space sets comprises at least one of a switching search space set group, an uplink search space set group, a downlink search space set group, or a skipping search space set group.

In an embodiment, the wireless terminal monitors PDCCH according to search space sets of the first group of search space sets for detecting one or more DCI formats when the type of the first group of search space sets is an uplink search space set group, and wherein one or more DCI formats carry information corresponding to an uplink scheduling.

In an embodiment, the wireless terminal monitors PDCCH according to search space sets of the first group of search space sets for detecting one or more DCI formats when the type of the first group of search space sets is a downlink search space set group, and wherein one or more DCI formats carry information corresponding to a downlink scheduling.

In an embodiment, the type of the first group of search space sets changes between at least two of the switching search space set group, the uplink search space set group, the downlink search space set group and a skipping search space set group when at least two types of the switching search space set group, the uplink search space set group, the downlink search space set group, or the skipping search space set group are configured for at least one of the search space sets in the first group of search space sets.

In an embodiment, the first group of search space sets is a search space set group including any one search space set of the plurality of search space sets configured for the active DL BWP for the wireless terminal. The changing PDCCH monitoring behavior between at least two types of search space set group can be indicated by a DCI or MAC CE (command entity) or a higher layer signaling.

In an embodiment, the type of the first group of search space sets is a skipping search space set group and the first group of search space sets includes at least one search space set associated with one or more DCI formats.

In an embodiment, based on the type of the first group of search space sets, the behavior (e.g. operations) of the wireless terminal monitoring the PDCCH may become: stop monitoring the PDCCH for detection of one or more DCI formats according to the first group of search space sets during a skipping period. Wherein the skipping period is not smaller than 0 and the unit of the skipping period is slot or millisecond.

In an embodiment, the one or more DCI formats include at least one of DCI format 0-1, DCI format 1-1, DCI format 0-2 or DCI format 1-2.

In an embodiment, a search space set configured for the wireless terminal is configured in at least one of a group of search space sets having the type of an uplink search space set group and a group of search space sets having the type of a downlink search space set group.

In an embodiment, the type of the first group of search space sets comprises the type of an uplink search space set group and/or a downlink search space set group.

In an embodiment, the type of the first group of search space sets is determined based on at least one of the control information or at least one condition.

In an embodiment, the control information includes at least one of search space set group information indicated by a DCI, the type of the uplink search space set group, the type of the downlink search space set group, and the release version configured by a higher layer signaling.

In an embodiment, the at least one condition is associated with at least one of a budget size difference between DCI format 0-1 and DCI format 1-1, or a budget size difference between DCI format 0-2 and DCI format 1-2.

In an embodiment, an indication indicating the type of the first group of search space sets being an uplink search space set group and/or a downlink search space set group is invalid or not presented when the control information is not configured for the wireless terminal.

In an embodiment, the control information includes at least one of the DCI format, the bitwidth of search space set group information indicated by the DCI, the type of the uplink search space set group, the type of the downlink search space set group, and a release version configured by a higher layer signaling.

In an embodiment, the type of the first group of search space sets is determined based on information indicated by a DCI and/or a release version when at least one of the type of a switching search space set group, the type of an uplink search space set group, the type of a downlink search space set group and the type of a skipping search space set group is configured for the wireless terminal.

In an embodiment, an identification of the first group of search space sets is determined based on at least one of search space set group information indicated by a DCI, the type of a switching search space set group, the type of an uplink search space set group, the type of a downlink search space set group, the type of a skipping search space set group, and a release version configured by a higher layer signaling.

In an embodiment, when the release version is set as release 17 or the future versions, the skipping search space set group can be supported by the wireless terminal. When the release version is set as release 16 or the former versions, the skipping search space set group cannot be supported by the wireless terminal. Wherein the higher layer signaling comprises the higher layer parameters related to search space set or search space set group, and/or the UE capability related to PDCCH monitoring according to a group of search space set group corresponding to a type of search space set group.

In an embodiment, the control information is associated with an indication of the minimum applicable scheduling offset.

In an embodiment, the indication of the minimum applicable scheduling offset comprises at least one of:
a DCI format,
the minimum applicable value of a scheduling offset between the DCI and a physical downlink shared channel, PDSCH, scheduled by the DCI,
the minimum applicable value of a scheduling offset between a slot containing the DCI triggering a set of the reference signal resources and another slot in which the set of reference signal resources is transmitted,
the minimum applicable value of a scheduling offset between the DCI and a physical uplink shared channel, PUSCH, scheduled by the DCI,
a value of a field indicating the minimum applicable scheduling offset,
a bit width of the field indicating the minimum applicable scheduling offset,
the number of values configured by a first higher layer parameter corresponding to the minimum applicable value of the scheduling offset between the DCI and the PDSCH scheduled by the DCI, or
the number of values configured by a second higher layer parameter corresponding to the minimum applicable value of the scheduling offset between the DCI and the PUSCH scheduled by the DCI.

In an embodiment, the first group of search space sets is configured as per (active) downlink bandwidth part.

In an embodiment, the control information is associated with at least one of a carrier indicator or a secondary cell dormancy indication in a DCI.

In an embodiment, based on the type of the first group of search space sets, the behavior (e.g. operations) of the wireless terminal monitoring the PDCCH may become: not monitoring the PDCCH according to the first group of search space sets in the cell indicated by the carrier indicator and the cells in a cell group bundled for monitoring PDCCH if the cell group bundled for monitoring PDCCH according to the first group of search space sets is configured for the wireless terminal. In this embodiment, the first group of search space sets may represent the group ID of the search space set group. In an embodiment, the group ID is indicated by the DCI or a default group ID configured by the higher layer signaling.

In an embodiment, the secondary cell dormancy indication is valid for one or more groups of serving cells. In this embodiment, based on the type of the first group of search space sets, the behavior (e.g. operations) of the wireless terminal monitoring the PDCCH may become: monitoring the PDCCH according to the first group of search space sets in at least one cell other than the one or more groups of serving cells.

In an embodiment, the control information is indicated by a DCI and comprises a bitmap indicating one or more cell groups where the wireless terminal monitors the PDCCH according to the first group of search space sets in the plurality of groups of search space sets.

In an embodiment, one or more bits of the bitmap indicates a group identification of one of the plurality of groups of search space sets for the corresponding cell or cell group.

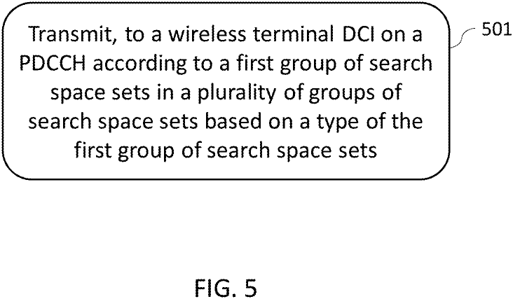

FIG. 5 shows a flowchart of a process according to an embodiment of the present disclosure. The process shown in FIG. 5 may be used in a wireless network node (e.g. BS) and comprises the following step:

Step 501: Transmit, to a wireless terminal DCI on a PDCCH according to a first group of search space sets in a plurality of groups of search space sets based on a type of the first group of search space sets.

In FIG. 5, the behavior (e.g. operations) of transmitting DCI to a wireless terminal (e.g. UE) according to a first group of search space sets in a plurality of groups of search space sets may change based on the type of the first group of search space sets. In this embodiment, the wireless terminal may report its capability of supporting search space set group switch (i.e. whether support search space set group switch). The wireless network node accordingly transmits control information associated with the first group of search space sets to the wireless terminal.

In an embodiment, the type of the first group of search space sets comprises at least one of a switching search space set group, an uplink search space set group, a downlink search space set group, or a skipping search space set group.

In an embodiment, the type of the first group of search space sets is an uplink search space set group, and the DCI is associated with one or more DCI formats carrying information corresponding to an uplink scheduling.

In an embodiment, the type of the first group of search space sets is a downlink search space set group, and the DCI is associated with one or more DCI formats carrying information corresponding to a downlink scheduling.

In an embodiment, the type of the first group of search space sets changes between at least two of the switching search space set group, the uplink search space set group, the downlink search space set group and a skipping search space set group when at least two types of the switching search space set group, the uplink search space set group, the downlink search space set group, or the skipping search space set group are configured for at least one of the search space sets in the first group of search space sets.

In an embodiment, the first group of search space sets is a search space set group including any one search space set of the plurality of search space sets configured for the DL BWP for the UE. The changing PDCCH monitoring behavior between at least two types of search space set group can be indicated by a DCI or MAC CE (command entity) or a higher layer signaling from the wireless network node to the wireless terminal.

In an embodiment, the type of the first group of search space sets is a skipping search space set group and the first group of search space sets includes at least one search space set associated with one or more DCI formats.

In an embodiment, based on the type of the first group of search space set, the behavior of the wireless network node may be: stop transmitting, to the wireless terminal, the DCI associated with one or more DCI formats according to the first group of search space sets during a skipping period. Wherein the skipping period is not smaller than 0 and the unit of the skipping period is slot or millisecond.

In an embodiment, the one or more DCI formats includes at least one of DCI format 0-1, DCI format 1-1, DCI format 0-2 or DCI format 1-2.

In an embodiment, the wireless network node configures a search space set for the wireless terminal in at least one of a group of search space sets having the type of an uplink search space set group and a group of search space sets having the type of a downlink search space set group.

In an embodiment, the type of the first group of search space sets comprises the type of an uplink search space set group and/or a downlink search space set group.

In an embodiment, the type of the first group of search space sets is determined based on at least one of the control information or at least one condition.

In an embodiment, the control information includes at least one of search space set group information indicated by a DCI, the DCI format, the type of the uplink search space set group, the type of the downlink search space set group, and the release version configured by a higher layer signaling.

In an embodiment, the at least one condition is associated with at least one of a budget size difference between DCI format 0-1 and DCI format 1-1, or a budget size difference between DCI format 0-2 and DCI format 1-2.

In an embodiment, an indication indicating the type of the first group of search space sets being an uplink search space set group and/or a downlink search space set group is invalid or not presented when wireless network node does not configure the control information for the wireless terminal, wherein the control information includes at least one of the DCI format, the bitwidth of search space set group information indicated by the DCI, the type of the uplink search space set group, the type of the downlink search space set group, and a release version configured by a higher layer signaling.

In an embodiment, the type of the first group of search space sets is determined based on information indicated by a DCI and/or a release version when at least one of the type of a switching search space set group, the type of an uplink search space set group, the type of a downlink search space set group and the type of a skipping search space set group is configured for the wireless terminal.

In an embodiment, an identification of the first group of search space sets is determined based on at least one of search space set group information indicated by a DCI, the type of a switching search space set group, the type of an uplink search space set group, the type of a downlink search space set group, the type of a skipping search space set group, and a release version configured by a higher layer signaling.

In an embodiment, when the release version is set as release 17 or the future versions, the skipping search space set group can be supported by the wireless terminal. When the release version is set as release 16 or the former versions, the skipping search space set group cannot be supported by the wireless terminal. In addition, the higher layer signaling comprises the higher layer parameters related to search space set or search space set group, and/or the UE capability related to PDCCH monitoring according to a group of search space set group corresponding to a type of search space set group.

In an embodiment, the control information is associated with an indication of the minimum applicable scheduling offset.

In an embodiment, the indication of the minimum applicable scheduling offset comprises at least one of: a DCI format, the minimum applicable value of a scheduling offset between the DCI and a physical downlink shared channel, PDSCH, scheduled by the DCI, the minimum applicable value of a scheduling offset between a slot containing the DCI triggering a set of the reference signal resources and another slot in which the set of reference signal resources is transmitted, the minimum applicable value of a scheduling offset between the DCI and a physical uplink shared channel, PUSCH, scheduled by the DCI, a value of a field indicating the minimum applicable scheduling offset, a bit width of the field indicating the minimum applicable scheduling offset, the number of values configured by a first higher layer parameter corresponding to the minimum applicable value of the scheduling offset between the DCI and the PDSCH scheduled by the DCI, or the number of values configured by a second higher layer parameter corresponding to the minimum applicable value of the scheduling offset between the DCI and the PUSCH scheduled by the DCI.

In an embodiment, the first group of search space sets is configured as per (active) downlink bandwidth part.

In an embodiment, the control information is associated with at least one of a carrier indicator or a secondary cell dormancy indication in a DCI.

In an embodiment, based on the type of the first group of search space set, the behavior of the wireless network node may be: not transmitting the DCI on the PDCCH according to the first group of search space sets in the cell indicated by the carrier indicator and the cells in a cell group bundled for transmitting the DCI one the PDCCH if the wireless network node configures the cell group bundled for transmitting the DCI on the PDCCH according to the first group of search space sets for the wireless terminal. In this embodiment, the first group of search space sets can represent the group ID of the search space set group, wherein the group ID is indicated by the DCI or a default group ID configured by the higher layer signaling.

In an embodiment, the secondary cell dormancy indication is valid for one or more groups of serving cells. In this embodiment, based on the type of the first group of search space set, the behavior of the wireless network node may be: transmitting the DCI on the PDCCH according to the first group of search space sets in at least one cell other than the one or more groups of serving cells.

In an embodiment, the control information is indicated by a DCI and comprises a bitmap indicating one or more cell groups where the wireless terminal monitors the PDCCH according to the first group of search space sets in the plurality of groups of search space sets.

In an embodiment, one or more bits of the bitmap indicates a group identification of one of the plurality of groups of search space sets for the corresponding cell or cell group.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
monitoring a physical downlink control channel (PDCCH) according to a first group of search space sets in a plurality of groups of search space sets based on a type of the first group of search space sets,
wherein the first group of search space sets in the plurality of groups of search space sets is determined based on control information,
wherein the type of the first group of search space sets comprises at least one of a switching search space set group, an uplink search space set group, a downlink search space set group, or a skipping search space set group.

2. The wireless communication method of claim 1, wherein the wireless terminal monitors PDCCH according to search space sets of the first group of search space sets for detecting one or more downlink control information (DCI) formats when the type of the first group of search space sets is the uplink search space set group, and wherein one or more DCI formats carry information corresponding to an uplink scheduling, or
wherein the wireless terminal monitors PDCCH according to search space sets of the first group of search space sets for detecting one or more DCI formats when the type of the first group of search space sets is the downlink search space set group, and wherein one or more DCI formats carry information corresponding to a downlink scheduling.

3. The wireless communication method of claim 1, wherein the type of the first group of search space sets changes between at least two of the switching search space set group, the uplink search space set group, the downlink search space set group and the skipping search space set group when at least two types of the switching search space set group, the uplink search space set group, the downlink search space set group, or the skipping search space set group are configured for at least one of the search space sets in the first group of search space sets.

4. The wireless communication method of claim 1 wherein the type of the first group of search space sets is the skipping search space set group and the first group of search space sets includes at least one search space set associated with one or more DCI formats,
wherein the monitoring the PDCCH according to the first group of search space sets in the plurality of groups of search space sets based on the type of the first group of search space sets comprises:
stop monitoring the PDCCH for detection of one or more DCI formats according to the first group of search space sets during a skipping period, wherein the one or more DCI formats include at least one of DCI format 0-1, DCI format 1-1, DCI format 0-2 or DCI format 1-2.

5. The wireless communication method of claim 1, wherein the type of the first group of search space sets comprises the type of at least one of the uplink search space set group or the downlink search space set group,
wherein the type of the first group of search space sets is determined based on at least one of the control information or at least one condition,
wherein the control information includes at least one of search space set group information indicated by a DCI, the DCI format, the type of the uplink search space set group, the type of the downlink search space set group, or the release version configured by a higher layer signaling, and
wherein the at least one condition is associated with at least one of a budget size difference between DCI format 0-1 and DCI format 1-1, or a budget size difference between DCI format 0-2 and DCI format 1-2.

6. The wireless communication method of claim 1, wherein an indication indicating the type of the first group of search space sets being at least one of the uplink search space set group or the downlink search space set group is invalid or not presented when the control information is not configured for the wireless terminal, and
wherein the control information includes at least one of the DCI format, the bitwidth of search space set group information indicated by the DCI, the type of the uplink search space set group, the type of the downlink search space set group, or a release version configured by a higher layer signaling.

7. The wireless communication method of claim 1, wherein the type of the first group of search space sets is determined based on at least one of information indicated by a DCI or a release version when at least one of the type of the switching search space set group, the type of the uplink search space set group, the type of the downlink search space set group and the type of the skipping search space set group is configured for the wireless terminal, or
wherein an identification of the first group of search space sets is determined based on at least one of search space set group information indicated by a DCI, the type of the switching search space set group, the type of the uplink search space set group, the type of the downlink search space set group, the type of the skipping search space set group, or a release version configured by a higher layer signaling.

8. The wireless communication method of claim 7, wherein the control information is associated with an indication of the minimum applicable scheduling offset,
wherein the indication of the minimum applicable scheduling offset comprises at least one of:
a DCI format,
the minimum applicable value of a scheduling offset between the DCI and a physical downlink shared channel (PDSCH) scheduled by the DCI,
the minimum applicable value of a scheduling offset between a slot containing the DCI triggering a set of the reference signal resources and another slot in which the set of reference signal resources is transmitted,
the minimum applicable value of a scheduling offset between the DCI and a physical uplink shared channel (PUSCH) scheduled by the DCI,
a value of a field indicating the minimum applicable scheduling offset,
a bit width of the field indicating the minimum applicable scheduling offset,
the number of values configured by a first higher layer parameter corresponding to the minimum applicable value of the scheduling offset between the DCI and the PDSCH scheduled by the DCI, or
the number of values configured by a second higher layer parameter corresponding to the minimum applicable value of the scheduling offset between the DCI and the PUSCH scheduled by the DCI,
wherein the first group of search space sets is configured as per downlink bandwidth part.

9. The wireless communication method of claim 7, wherein the control information is associated with at least one of a carrier indicator or a secondary cell dormancy indication in a DCI, and
wherein the monitoring the PDCCH according to the first group of search space sets in the plurality of groups of search space sets based on the type of the first group of search space sets comprises:
not monitoring the PDCCH according to the first group of search space sets in the cell indicated by the carrier indicator and the cells in a cell group bundled for monitoring PDCCH if the cell group bundled for monitoring PDCCH according to the first group of search space sets is configured for the wireless terminal, or
monitoring the PDCCH according to the first group of search space sets in at least one cell other than the one or more groups of serving cells, wherein the secondary cell dormancy indication is valid for one or more groups of serving cells.

10. A wireless communication method for use in a wireless network node, the method comprising:
transmitting, to a wireless terminal, downlink control information (DCI) on a physical downlink control channel (PDCCH) according to a first group of search space sets in a plurality of groups of search space sets based on a type of the first group of search space sets,
wherein the first group of search space sets in the plurality of groups of search space sets is determined based on control information,
wherein the type of the first group of search space sets comprises at least one of a switching search space set group, an uplink search space set group, a downlink search space set group, or a skipping search space set group.

11. The wireless communication method of claim 10, wherein the type of the first group of search space sets is the uplink search space set group, and the DCI is associated with one or more DCI formats carrying information corresponding to an uplink scheduling, or
wherein the type of the first group of search space sets is the downlink search space set group, and the DCI is associated with one or more DCI formats carrying information corresponding to a downlink scheduling.

12. The wireless communication method of claim 10, wherein the type of the first group of search space sets changes between at least two of the switching search space set group, the uplink search space set group, the downlink search space set group and the skipping search space set group when at least two types of the switching search space set group, the uplink search space set group, the downlink search space set group, or the skipping search space set group are configured for at least one of the search space sets in the first group of search space sets.

13. The wireless communication method of claim 10, wherein the type of the first group of search space sets is the skipping search space set group and the first group of search space sets includes at least one search space set associated with one or more DCI formats,
wherein the transmitting, to the wireless terminal, the DCI on the PDCCH according to the first group of search space sets in the plurality of search space sets based on the type of the first group of search space sets comprises:
stop transmitting, to the wireless terminal, the DCI associated with one or more DCI formats according to the first group of search space sets during a skipping period,
wherein the one or more DCI formats includes at least one of DCI format 0-1, DCI format 1-1, DCI format 0-2 or DCI format 1-2.

14. The wireless communication method of claim 10, wherein the type of the first group of search space sets comprises the type of at least one of the uplink search space set group or the downlink search space set group,
wherein the type of the first group of search space sets is determined based on at least one of the control information or at least one condition, and
wherein the control information includes at least one of search space set group information indicated by a DCI, the DCI format, the type of the uplink search space set group, the type of the downlink search space set group, or the release version configured by a higher layer signaling, and
wherein the at least one condition is associated with at least one of a budget size difference between DCI format 0-1 and DCI format 1-1, or a budget size difference between DCI format 0-2 and DCI format 1-2.

15. The wireless communication method of claim 10, wherein an indication indicating the type of the first group of search space sets being at least one of the uplink search space set group or downlink search space set group is invalid or not presented when wireless network node does not configure the control information for the wireless terminal, and
wherein the control information includes at least one of the DCI format, the bitwidth of search space set group information indicated by the DCI, the type of the uplink search space set group, the type of the downlink search space set group, or a release version configured by a higher layer signaling.

16. The wireless communication method of claim 10, wherein the type of the first group of search space sets is determined based on at least one of information indicated by a DCI or a release version when at least one of the type of the switching search space set group, the type of the uplink search space set group, the type of the downlink search space set group and the type of the skipping search space set group is configured for the wireless terminal, or
wherein an identification of the first group of search space sets is determined based on at least one of search space set group information indicated by a DCI, the type of the switching search space set group, the type of the uplink search space set group, the type of the downlink search space set group, the type of the skipping search space set group, or a release version configured by a higher layer signaling.

17. The wireless communication method of claim 16, wherein the control information is associated with an indication of the minimum applicable scheduling offset,
wherein the indication of the minimum applicable scheduling offset comprises at least one of:
a DCI format,
the minimum applicable value of a scheduling offset between the DCI and a physical downlink shared channel (PDSCH) scheduled by the DCI,
the minimum applicable value of a scheduling offset between a slot containing the DCI triggering a set of the reference signal resources and another slot in which the set of reference signal resources is transmitted,
the minimum applicable value of a scheduling offset between the DCI and a physical uplink shared channel (PUSCH) scheduled by the DCI,
a value of a field indicating the minimum applicable scheduling offset,
a bit width of the field indicating the minimum applicable scheduling offset,
the number of values configured by a first higher layer parameter corresponding to the minimum applicable value of the scheduling offset between the DCI and the PDSCH scheduled by the DCI, or
the number of values configured by a second higher layer parameter corresponding to the minimum applicable value of the scheduling offset between the DCI and the PUSCH scheduled by the DCI,
wherein the first group of search space sets is configured as per downlink bandwidth part.

18. The wireless communication method of claim 16, wherein the control information is associated with at least one of a carrier indicator or a secondary cell dormancy indication in a DCI,
wherein the transmitting, to the wireless terminal, the DCI on the PDCCH according to the first group of search space sets in the plurality of groups of search space sets based on the type of the first group of search space sets comprises:
not transmitting the DCI on the PDCCH according to the first group of search space sets in the cell indicated by the carrier indicator and the cells in a cell group bundled for transmitting the DCI one the PDCCH if the wireless network node configures the cell group bundled for transmitting the DCI on the PDCCH according to the first group of search space sets for the wireless terminal, or
transmitting the DCI on the PDCCH according to the first group of search space sets in at least one cell other than the one or more groups of serving cells, wherein the secondary cell dormancy indication is valid for one or more groups of serving cells.

19. A wireless terminal, comprising:
a processor, configured to monitor a physical downlink control channel (PDCCH) according to a first group of search space sets in a plurality of groups of search space sets based on a type of the first group of search space sets,
wherein the first group of search space sets in the plurality of groups of search space sets is determined based on control information,
wherein the type of the first group of search space sets comprises at least one of a switching search space set group, an uplink search space set group, a downlink search space set group, or a skipping search space set group.

20. A wireless network node, comprising:
a processor and a communication unit, configured to transmit, to the wireless terminal, downlink control information (DCI) on a physical downlink control channel (PDCCH) according to a first group of search space sets in a plurality of groups of search space sets based on a type of the first group of search space sets,
wherein the first group of search space sets in the plurality of groups of search space sets is determined based on control information,
wherein the type of the first group of search space sets comprises at least one of a switching search space set group, an uplink search space set group, a downlink search space set group, or a skipping search space set group.
